(19) United States
(12) Patent Application Publication
(10) Pub. No.: US 2003/0099361 A1
(43) Pub. Date: May 29, 2003

(54) Key exchange apparatus, method, program, and recording medium recording such program

(75) Inventor: Tomoyuki Uchida, Tokyo (JP)

Correspondence Address: YOUNG & THOMPSON, 745 SOUTH 23RD STREET 2ND FLOOR, ARLINGTON, VA, 22202

(73) Assignee: YUN FACTORY INC., TOKYO (JP)

(21) Appl. No.: 10/300,743

(22) Filed: Nov. 21, 2002

(30) Foreign Application Priority Data
Nov. 28, 2001 (JP) P2001-362677
Jul. 11, 2002 (JP) P2002-203186

(51) Int. Cl. H04L 9/00

(52) U.S. Cl. 380/277

(57) ABSTRACT

A key (such as a public key) used for encryption of information is easily obtained.

A public key of A used for encryption when information is transmitted to a first communication terminal 100a is transmitted, a second communication terminal 100b receives the public key of A, a public key of B used for encryption when information is transmitted to the second communication terminal 100b in response to the reception of the public key of A, and the first communication terminal 100a receives the public key of B. As a result, the public keys are exchanged between the first communication terminal 100a and the second communication terminal 100b, and consequently the public key is easily obtained.

### BACKGROUND OF INVENTION

1. Field of Invention

The present invention relates to obtaining a key (such as a public key) used for encryption when information is transmitted.

2. Description of the Related Art

Communication using electronic mails over the Internet has been widely practiced. Since the electronic mail is communicated over the Internet, a third party may illegally obtain the electronic mail. Thus, the electronic mail may be encrypted. Methods for the encryption include a public key system.

In the public key system, a key used for encryption for transmitting information to a communication apparatus A is passed to a communication apparatus B as a public key, and the communication apparatus A keeps a key for decrypting information encrypted by the public key as a secret key. The communication apparatus B encrypts an electronic mail or the like using the public key, and then transmits it to the communication apparatus A. Then, the communication apparatus A decrypts the transmitted electronic mail using the secret key.

With the public key system, authentication is also available. Namely, an ID or the like of the communication apparatus A is encrypted using the secret key of the communication apparatus A, and the communication apparatus B decrypts the encrypted ID or the like using the public key corresponding to the secret key. With this system, since the ID or the like encrypted by an secret key other than the secret key of the communication apparatus A is not decrypted, it is authenticated that the ID or the like is encrypted by the secret key of the communication apparatus A, namely, the ID or the like is transmitted from the communication apparatus A if the ID or the like is decrypted.

### SUMMARY OF INVENTION

However, if a third party transmits its public key to the communication apparatus B while disguising the key as the public key of the communication apparatus A, the encryption and authentication in the public key system becomes ineffective. The communication apparatus B falsely recognizes the third party as the communication apparatus A, and transmits and receives an electronic mail and the like.

In view of the foregoing, a public key of a communication apparatus A is recorded on a server, and the public key is obtained from the server. If it is strictly checked whether a third party is impersonating or not when the key is recorded on the server, the third is prevented part from impersonating.

However, if a system where a public key is registered on a server is adopted, it is impossible to use the public key system unless the opposite party has registered the key. Thus, it is not simple to adopt the public key system.

The purpose of the present invention is to facilitate obtaining a key (such as a public key) used for encryption when information is transmitted.

According to the present invention described in claim 1, a key exchange apparatus includes: a first key transmission unit for transmitting a first encryption key used for encrypting when information is transmitted to a first communication terminal; a first key reception unit for receiving the first encryption key; a second key transmission unit for transmitting a second encryption key used for encrypting when information is transmitted to a second communication terminal in response to reception of the first encryption key; and a second key reception unit for receiving the second encryption key.

The first encryption key and the second encryption key here are public keys, for example.

With the key exchange apparatus constituted as described above, since the first encryption key and the second encryption key can be exchanged, keys used for the encryption between the first communication terminal and the second communication terminal are obtained.

According to the present invention described in claim 2, a key exchange apparatus includes: a first key transmission unit for transmitting a first encryption key used for encrypting when information is transmitted to a first communication terminal; and a second key reception unit for receiving a second encryption key transmitted in response to the transmission of the first encryption key, and used for encrypting when information is transmitted to a second communication terminal.

According to the present invention described in claim 3, a key exchange apparatus includes: a first key reception unit for receiving a first encryption key used for encrypting when information is transmitted to a first communication terminal; and a second key transmission unit for transmitting a second encryption key used for encrypting when information is transmitted to a second communication terminal in response to reception of the first encryption key.

The present invention described in claim 4, is the key exchange apparatus according to claim 1, wherein the first encryption key and the second encryption key are transmitted in response to a transmission of an electronic mail communicated between the first communication terminal and the second communication terminal, and the first encryption key and the second encryption key are received in response to a reception of an electronic mail communicated between the first communication terminal and the second communication terminal.

The first encryption key and the second encryption key are exchanged by transmitting and receiving an electronic mail. For example, operating a mailer which is software for transmitting and receiving an electronic mail can exchange the first encryption key and the second encryption key. Thus, the first encryption key and the second encryption key are exchanged easily.

The present invention described in claim 5, is the key exchange apparatus according to claim 2, wherein the first encryption key is transmitted in response to a transmission of an electronic mail from the first communication terminal to the second communication terminal, and the second encryption key is received in response to a reception of an electronic mail by the first communication terminal, the electronic mail transmitted from the second communication terminal.

The present invention described in claim 6, is the key exchange apparatus according to claim 3, wherein the first encryption key is received in response to a reception of an electronic mail by the second communication terminal, the electronic mail transmitted from the first communication terminal, and the second encryption key is transmitted in response to a transmission of an electronic mail from the second communication terminal to the first communication terminal.

The present invention described in claim 7, is the key exchange apparatus according to claim 5, wherein the first key transmission unit transmits the first encryption key while the first encryption key is attached to a plaintext electronic mail if the second encryption key has not been received by the second key reception unit.

If the second encryption key has not been received, the first encryption key and the second encryption key have not been exchanged. Then, if the first encryption key is transmitted, the first encryption key and the second encryption key will be exchanged.

The present invention described in claim 8, is the key exchange apparatus according to claim 5, wherein an electronic mail encrypted by the second encryption key is transmitted to the second communication terminal if the second encryption key has been received by the second key reception unit.

If the second encryption key is received, the first encryption key and the second encryption key are exchanged. Then, when an electronic mail is encrypted and transmitted, a third party is prevented from illegally obtaining the electronic mail.

According to the present invention described in claim 9, the key exchange apparatus according to claim 4 further includes: a first signature appending unit for attaching first signature information encrypted by a first decryption key which can decrypt information encrypted by the first encryption key to a first electronic mail transmitted from the first communication terminal to the second communication terminal; a first signature verifying unit for receiving the first electronic mail, and authenticating the first signature information by decrypting the first signature information with the first encryption key; a second signature appending unit for attaching second signature information encrypted by a second decryption key which can decrypt information encrypted by the second encryption key to a second electronic mail transmitted from the second communication terminal to the first communication terminal; and a second signature verifying unit for receiving the second electronic mail, and authenticating the second signature information by decrypting the second signature information with the second encryption key.

The first decryption key and the second decryption key here are secret keys, for example.

Since the first encryption key and the second encryption key are exchanged, authentication is conducted between the first communication terminal and the second communication terminal based on a so-called electronic signature.

According to the present invention described in claim 10, the key exchange apparatus according to claim 5 further includes: a first signature appending unit for attaching first signature information encrypted by a first decryption key which can decrypt information encrypted by the first encryption key to a first electronic mail transmitted from the first communication terminal to the second communication terminal; and a second signature verifying unit for receiving the second electronic mail attached with second signature information encrypted by a second decryption key which can decrypt information encrypted by the second encryption key, and transmitted from the second communication terminal to the first communication terminal, and authenticating the second signature information by decrypting the second signature information with the second encryption key.

According to the present invention described in claim 11, the key exchange apparatus according to claim 6 further includes: a first signature verifying unit for receiving the first electronic mail attached with first signature information encrypted by a first decryption key which can decrypt information encrypted by the first encryption key, and transmitted from the first communication terminal to the second communication terminal, and authenticating the first signature information by decrypting the first signature information with the first encryption key; and a second signature appending unit for attaching second signature information encrypted by a second decryption key which can decrypt information encrypted by the second encryption key to a second electronic mail transmitted from the second communication terminal to the first communication terminal.

According to the present invention described in claim 12, the key exchange apparatus according to claim 9 further includes: a first delivery acknowledgement information transmission unit for transmitting first transmission acknowledgement information showing the first electronic mail has been delivered from the second communication terminal to the first communication terminal if the first signature verifying unit authenticates the first signature information; and a second delivery acknowledgement information transmission unit for transmitting second transmission acknowledgement information showing the second electronic mail has been delivered from the first communication terminal to the second communication terminal if the second signature verifying unit authenticates the second signature information.

Since authentication is conducted between the first communication terminal and the second communication terminal, it is possible to transmit such information as indicating that an electronic mail has delivered, which should not be disclosed to a third party.

According to the present invention described in claim 13,the key exchange apparatus according to claim 10 further includes a second delivery acknowledgement information transmission unit for transmitting second delivery acknowledgement information showing the second electronic mail has been delivered from the first communication terminal to the second communication terminal if the second signature verifying unit authenticates the second signature information.

According to the present invention described in claim 14, the key exchange apparatus according to claim 11 further includes a first delivery acknowledgement information transmission unit for transmitting first delivery acknowledgement information showing the first electronic mail has been delivered from the second communication terminal to the first communication terminal if the first signature verifying unit authenticates the first signature information.

According to the present invention described in claim 15, the key exchange apparatus according to claim 9 further includes: a first electronic mail cancel request unit for transmitting a cancel request for the first electronic mail from the first communication terminal; a first electronic mail cancel unit for deleting the first electronic mail from the second communication terminal if the first signature verifying unit authenticates the first signature information, and the cancel request for the first electronic mail is received; a second electronic mail cancel request unit for transmitting a cancel request for the second electronic mail from the second communication terminal; and a second electronic mail cancel unit for deleting the second electronic mail from the first communication terminal if the second signature verifying unit authenticates the second signature information, and the cancel request for the second electronic mail is received.

Authentication is conducted between the first communication terminal and the second communication terminal. Thus, it is possible to confirm that such a request as canceling an electronic mail, which should not be illegally used, is transmitted from a correct sender of the electronic mail. Therefore, it is safe to delete an electronic mail on request for canceling the electronic mail.

According to the present invention described in claim 16,the key exchange apparatus according to claim 10 further includes: a first electronic mail cancel request unit for transmitting a cancel request for the first electronic mail from the first communication terminal; and a second electronic mail cancel unit for deleting the second electronic mail from the first communication terminal if the second signature verifying unit authenticates the second signature information, and a cancel request for the second electronic mail is received.

According to the present invention described in claim 17, the key exchange apparatus according to claim 11 further includes: a first electronic mail cancel unit for deleting the first electronic mail from the second communication terminal if the first signature verifying unit authenticate the first signature information, and a cancel request for the first electronic mail is received; and a second electronic mail cancel request unit for transmitting a cancel request for the second electronic mail from the second communication terminal.

According to the present invention described in claim 18, the key exchange apparatus according to claim 4 further includes: a first program identification information attaching unit for attaching first program identification information indicating whether a first electronic mail transmitted from the first communication terminal to the second communication terminal is encrypted with the second encryption key; a first electronic mail decoding unit for receiving the first electronic mail, and decoding the first electronic mail if the first program identification information indicates the encryption with the second encryption key; a second program identification information attaching unit for attaching second program identification information indicating whether a second electronic mail transmitted from the second communication terminal to the first communication terminal is encrypted with the first encryption key; and a second electronic mail decoding unit for receiving the second electronic mail, and decoding the second electronic mail if the second program identification information indicates the encryption with the first encryption key.

According to the present invention described in claim 19, the key exchange apparatus according to claim 5 further includes: a first program identification information attaching unit for attaching first program identification information indicating whether a first electronic mail transmitted from the first communication terminal to the second communication terminal is encrypted with the second encryption key; and a second electronic mail decoding unit for receiving the second electronic mail attached with second program identification information indicating whether the second electronic mail is encrypted with the first encryption key, and transmitted from the second communication terminal to the first communication terminal, and decoding the second electronic mail if the second program identification information indicates the encryption with the first encryption key.

According to the present invention described in claim 20, the key exchange apparatus according to claim 6 further includes: a first electronic mail decoding unit for receiving the first electronic mail attached with first program identification information indicating whether the first electronic mail is encrypted with the second encryption key, and transmitted from the first communication terminal to the second communication terminal, and decoding the first electronic mail if the first program identification information indicates the encryption with the second encryption key; and a second program identification information attaching unit for attaching second program identification information indicating whether a second electronic mail transmitted from the second communication terminal to the first communication terminal is encrypted with the first encryption key.

According to the present invention described in claim 21, the key exchange apparatus according to claim 5 further includes a first electronic mail encryption unit for encrypting a first electronic mail transmitted from the first communication terminal to the multiple second communication terminals with the second encryption key corresponding to the individual second communication terminal.

According to the present invention described in claim 22, the key exchange apparatus according to claim 6 further includes a second electronic mail encryption unit for encrypting a second electronic mail transmitted from the second communication terminal to the multiple first communication terminals with the first encryption key corresponding to the individual first communication terminal.

The present invention described in claim 23, is the key exchange apparatus according to claim 4, wherein the one first communication terminal transmits an electronic mail for a mailing list to the other first communication terminal through the second communication terminal, the second key transmission unit transmits a common key in addition to the second encryption key, the second key reception unit receives the second encryption key and the common key, and the electronic mail for a mailing list is encrypted and decrypted with the common key.

The present invention described in claim 24, is the key exchange apparatus according to claim 5, wherein the one first communication terminal transmits an electronic mail for a mailing list to the other first communication terminal through the second communication terminal, the second key reception unit receives the second encryption key and a common key, and the electronic mail for a mailing list is encrypted and decrypted with the common key.

The present invention described in claim 25, is the key exchange apparatus according to claim 6, wherein the one first communication terminal transmits an electronic mail for a mailing list to the other first communication terminal through second communication terminal, the second key transmission unit transmits a common key in addition to the second encryption key, and the electronic mail for a mailing list is encrypted and decrypted with the common key.

The present invention described in claim 26, is the key exchange apparatus according to claim 23, wherein the common key is changeable.

According to the present invention described in claim 27, the key exchange apparatus according to claim 4 further includes: a first encryption key trust level setting unit for setting a trust level of the first encryption key received by the first key reception unit; and a second encryption key trust level setting unit for setting a trust level of the second encryption key received by the second key reception unit.

According to the present invention described in claim 28, the key exchange apparatus according to claim 5 further includes a second encryption key trust level setting unit for setting a trust level of the second encryption key received by the second key reception unit.

According to the present invention described in claim 29, the key exchange apparatus according to claim 6 further includes a first encryption key trust level setting unit for setting a trust level of the first encryption key received by the first key reception unit.

The present invention described in claim 30, is the key exchange apparatus according to claim 27, wherein the first encryption key trust level setting unit sets the trust level of the first encryption key based on a route along which the first encryption key is transmitted, and the second encryption key trust level setting unit sets the trust level of the second encryption key based on a route along which the second encryption key is transmitted.

It seems that the route along which the first encryption key is transmitted is substantially the same as that which the second encryption key is transmitted when the first encryption key and the second encryption key are changed. Therefore, on the basis of the route along which the first and the second encryption keys are transmitted, it can be judged whether the first and the second encryption keys are appropriately changed, and whether the first and the second encryption keys are inappropriately changed by the third party.

The present invention described in claim 31, is the key exchange apparatus according to claim 28, wherein the second encryption key trust level setting unit sets the trust level of the second encryption key based on a route along which the second encryption key is transmitted.

The present invention described in claim 32, is the key exchange apparatus according to claim 29, wherein the first encryption key trust level setting unit sets the trust level of the first encryption key based on a route along which the first encryption key is transmitted.

The present invention described in claim 33, is the key exchange apparatus according to claim 27, wherein the trust level of the first encryption key or the second encryption key is set by attached information of an electronic mail.

The present invention described in claim 34, is the key exchange apparatus according to claim 27, wherein the trust level of the first encryption key or the second encryption key is set by whether an incorrect encryption key is received.

The present invention described in claim 35, is the key exchange apparatus according to claim 27, wherein the trust level of the first encryption key or the second encryption key is entered by a user.

According to the present invention described in claim 36, the key exchange apparatus according to claim 27 further includes: a first encryption key trust level treating unit for treating the first encryption key based on the trust level of the first encryption key; and a second encryption key trust level treating unit for treating the second encryption key based on the trust level of the second encryption key.

According to the present invention described in claim 37, the key exchange apparatus according to claim 28 further includes: a second encryption key trust level treating unit for treating the second encryption key based on the trust level of the second encryption key.

According to the present invention described in claim 38, the key exchange apparatus according to claim 29 further includes: a first encryption key trust level treating unit for treating the first encryption key based on the trust level of the first encryption key.

The present invention described in claim 39, is the key exchange apparatus according to claim 36, wherein the treating the first encryption key or the second encryption key is to invalidate the first encryption key or the second encryption key.

The present invention described in claim 40, is the key exchange apparatus according to claim 36, wherein the treating the first encryption key or the second encryption key is to record the first encryption key or the second encryption key.

The present invention described in claim 41, is the key exchange apparatus according to claim 36, wherein the treating the first encryption key or the second encryption key is to provide warning.

According to the present invention described in claim 42, a key exchange method includes: a first key transmission step for transmitting a first encryption key used for encrypting when information is transmitted to a first communication terminal; a first key reception step for receiving the first encryption key; a second key transmission step for transmitting a second encryption key used for encrypting when information is transmitted to a second communication terminal in response to reception of the first encryption key; and a second key reception step for receiving the second encryption key.

According to the present invention described in claim 43, a key exchange method includes: a first key transmission step for transmitting a first encryption key used for encrypting when information is transmitted to a first communication terminal; and a second key reception step for receiving a second encryption key transmitted in response to the transmission of the first encryption key, and used for encrypting when information is transmitted to a second communication terminal.

According to the present invention described in claim 44, a key exchange method includes: a first key reception step for receiving a first encryption key used for encrypting when information is transmitted to a first communication terminal; and a second key transmission step for transmitting a second encryption key used for encrypting when information is transmitted to a second communication terminal in response to reception of the first encryption key.

The present invention described in claim 45, is a program of instructions for execution by the computer to perform a key exchange process, the key exchange process including: a first key transmission processing for transmitting a first encryption key used for encrypting when information is transmitted to a first communication terminal; and a second key reception processing for receiving a second encryption key transmitted in response to the transmission of the first encryption key, and used for encrypting when information is transmitted to a second communication terminal.

The present invention described in claim 46, is a program of instructions for execution by the computer to perform a key exchange process, the key exchange process including: a first key reception processing for receiving a first encryption key used for encrypting when information is transmitted to a first communication terminal; and a second key transmission processing for transmitting a second encryption key used for encrypting when information is transmitted to a second communication terminal in response to reception of the first encryption key.

The present invention described in claim 47, is a computer-readable medium having a program of instructions for execution by the computer to perform a key exchange process, the key exchange process including: a first key transmission processing for transmitting a first encryption key used for encrypting when information is transmitted to a first communication terminal; and a second key reception processing for receiving a second encryption key transmitted in response to the transmission of the first encryption key, and used for encrypting when information is transmitted to a second communication terminal.

The present invention described in claim 48, is a computer-readable medium having a program of instructions for execution by the computer to perform a key exchange process, the key exchange process including: a first key reception processing for receiving a first encryption key used for encrypting when information is transmitted to a first communication terminal; and a second key transmission processing for transmitting a second encryption key used for encrypting when information is transmitted to a second communication terminal in response to reception of the first encryption key.

### BRIEF DESCRIPTION OF THE DRAWINGS

FIG. 1 is a block diagram showing a constitution of a computer 100 on which a key exchange apparatus relating to an embodiment of the present invention is implemented;

FIG. 2 is a descriptive drawing describing formation of a trusted section relating to the embodiment of the present invention;

FIG. 3 is a flowchart showing an operation of a computer 100a (a first communication terminal);

FIG. 4 is a flowchart showing an operation of a computer 100b (a second communication terminal);

FIG. 5 is a flowchart showing reception processing for a mailing list registration request mail on the computer (the second communication terminal) 100b of an administrator;

FIG. 6 is a flowchart showing reception processing for a replay mail corresponding to the mailing list registration request mail on the computer 100a of a registration requesting person;

FIG. 7 is a flowchart showing replay processing when a person registered to a mailing list uses the computer (the first communication terminal) 100a to transmit a mail to the computer (the first communication terminal) 100a of another person registered to the mailing list through the computer (the second communication terminal) 100b;

FIG. 8 is a drawing showing an example of key information 161 including key information of an own party (FIG. 8(a)) and key information of an opposite party (FIG. 8(b));

FIG. 9 is a drawing showing an example of key trust level information 162;

FIG. 10 is a drawing showing an example of mail control information 163;

FIG. 11 is a block diagram describing a flow of data through a part of the constitution of the computer 100a (the first communication terminal);

FIG. 12 is a block diagram describing a flow of data through a part of the constitution of the computer 100b (the second communication terminal); and

FIG. 13 is a drawing showing an example where a proxy server 112 is provided outside the computer 100.

### DESCRIPTION OF THE PREFERRED EMBODIMENTS

The following section describes embodiments of the present invention while referring to drawings.

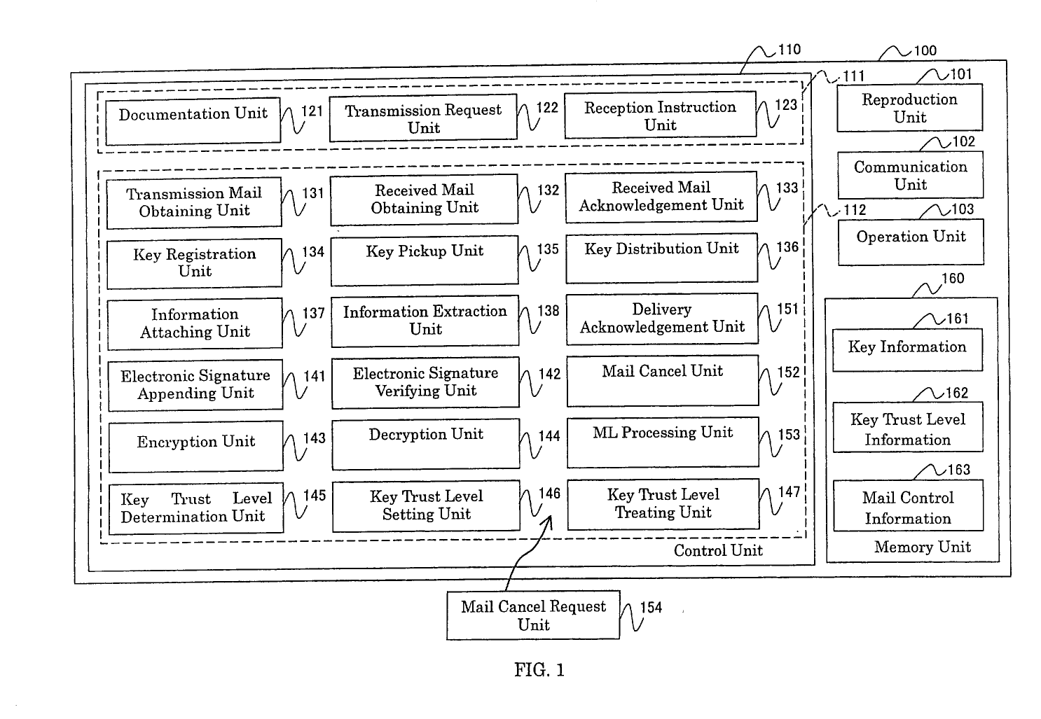

FIG. 1 is a block diagram showing a constitution of a computer 100 on which a key exchange apparatus relating to an embodiment of the present invention is implemented.

The computer 100 is provided with reproduction unit 101, communication unit 102, operation unit 103, control unit 110, and memory unit 160.

The reproduction unit 101 comprises a display and a speaker, and reproduces an image and sound of an electronic mail and the like.

The communication unit 102 is connected with a network such as the Internet.

The operation unit 103 comprises a keyboard, a pen, a button, a mouse, and a microphone, and a user enters information through it, and operates it.

The control unit 110 comprises a CPU, and includes a mailer 111 and a proxy server 112. The control unit 110 executes a mailer program which makes the CPU function as the mailer 111 following specified communication protocols such as SMTP and POP regarding transmitting and receiving an electronic mail, and a proxy server program (the key exchange apparatus according to the embodiment of the present invention) which makes the CPU function as the proxy server 112 which forms a trusted section between the computers 100, and the like.

The memory unit 160 stores key information 161 for registering an encryption key, key trust level information 162 for setting a trust level of the encryption key, mail control information 163 for controlling transmission and reception of an electronic mail, an electronic mail, the mailer program, and the proxy server program.

The mailer 111 is provided with documentation unit 121 for creating an electronic mail, transmission request unit 122 for requesting a transmission of an electronic mail, and reception instruction unit 123 for instructing reception of an electronic mail from the mail server.

The proxy server 112 comprises transmission mail obtaining unit 131 for obtaining an electronic mail to be transmitted from the mailer 111, received mail obtaining unit 132 for obtaining an electronic mail to be received from the communication unit 102, received mail acknowledgement unit 133 for notifying the mailer 111 of a received electronic mail, key registration unit 134 for registering an encryption key to the key information 161 of the memory unit 160, key pickup unit 135 for picking up an encryption key from the memory unit 160, key distribution unit 136 for distributing a key to an opposite party of communication (such as a destination of an electronic mail, a sender of an electronic mail, an administrator of a mailing list, and a registration requesting person of a mailing list), information attaching unit 137 for attaching information to an electronic mail, information extraction unit 138 for extracting necessary information from an electronic mail, electronic signature appending unit 141 for appending an electronic signature to an electronic mail to be transmitted, electronic signature verifying unit 142 for verifying an electronic signature of a received electronic mail, encryption unit 143 for encrypting an electronic mail, decryption unit 144 for decrypting an encrypted electronic mail, key trust level determination unit 145 for determining a trust level, key trust level setting unit 146 for setting a key trust level to the key trust level information 162 of the memory unit 160, key trust level treating unit 147 for conducting treatment relating to an electronic mail based on the key trust level information 162 of the memory unit 160, delivery acknowledgement unit 151 for notifying transmission of an electronic mail, mail cancel unit 152 for canceling an electronic mail, and ML (mailing list) processing unit 153 for conducting processing relating to a mailing list.

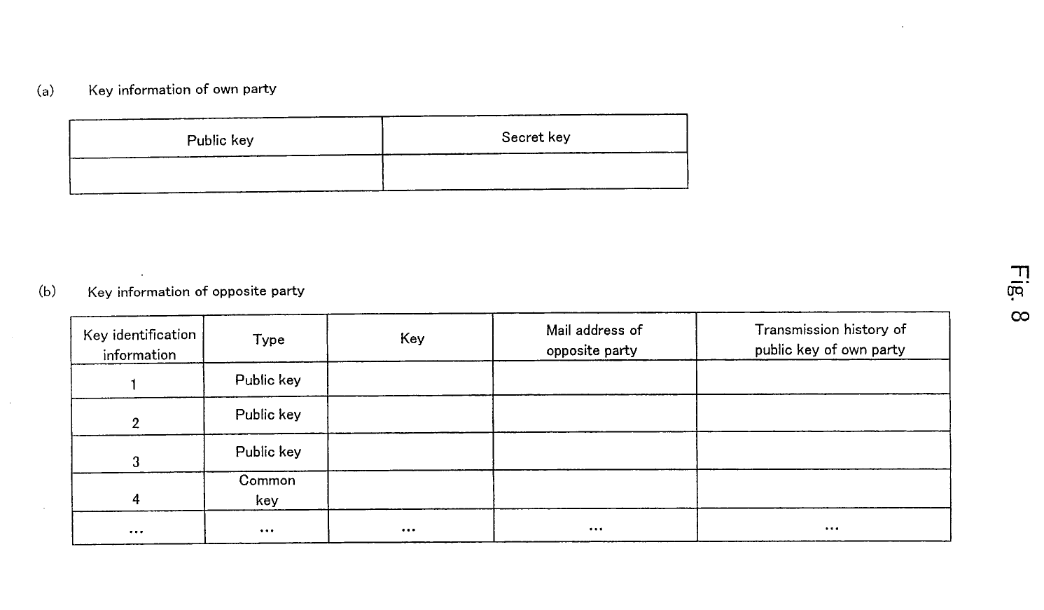

FIG. 8 shows an example of the key information 161. Own party key information in FIG. 8(a) includes a public key and a secret key. Opposite party key information in FIG. 8(b) includes key identification information, a type (identifying a public key or a common key), a key, a mail address of an opposite party, and transmission history of a public key of an own party. The opposite party key information may be shared by transmitting it to or receiving it from other parties.

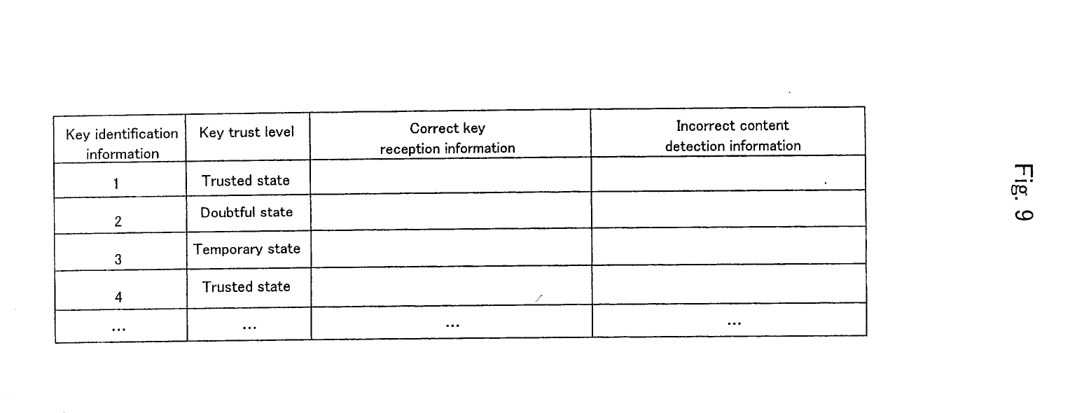

FIG. 9 shows an example of the key trust level information 162. The key trust level information in FIG. 9 includes key identification information, a key trust level, correct key reception information storing the number of times a correct key is received, path information on a correct reception, and the like, and incorrect content detection information storing the number of times an incorrect content is detected in an electronic mail, path information on an incorrect reception, and the like.

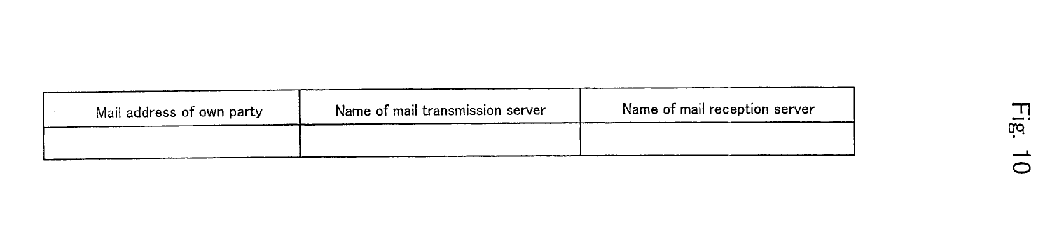

FIG. 10 shows an example of the mail control information 163. The mail control information in FIG. 10 includes a mail address of an own party, a name of a mail transmission server, and a name of a mail reception server.

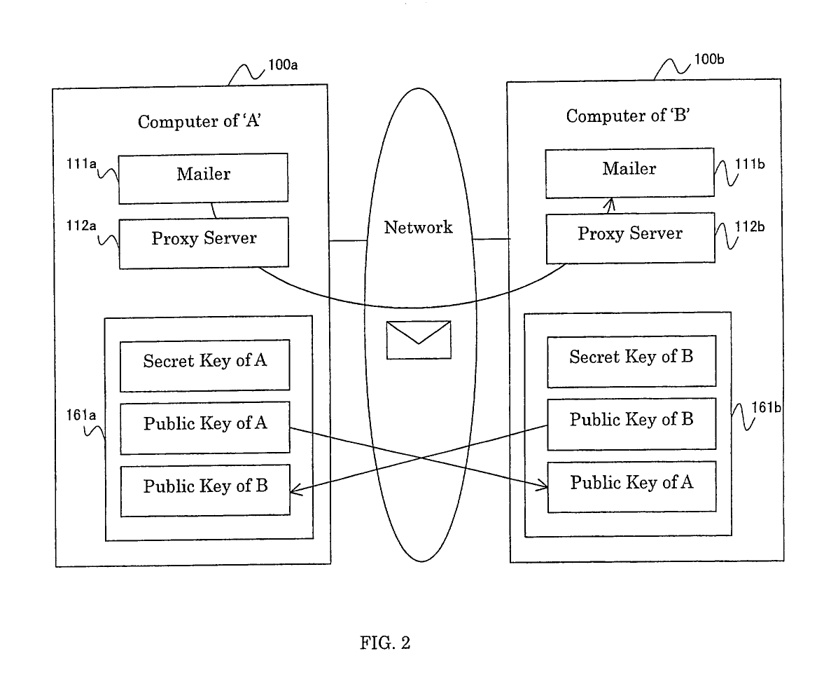

FIG. 2 is a descriptive drawing describing a trusted section relating to the embodiment of the present invention.

A proxy server 112 forms a trusted section between itself and a computer 100 to communicate with, and an electronic mail is transmitted to the computers 100 where the trusted section is formed between itself and the computer 100. The following (1), (2), and (3) show specific functions of forming a trusted section.

(1) Exchange encryption keys

(2) Attach an electronic signature to an electronic mail, and check an electronic signature

(3) Encrypt and decrypt an electronic mail

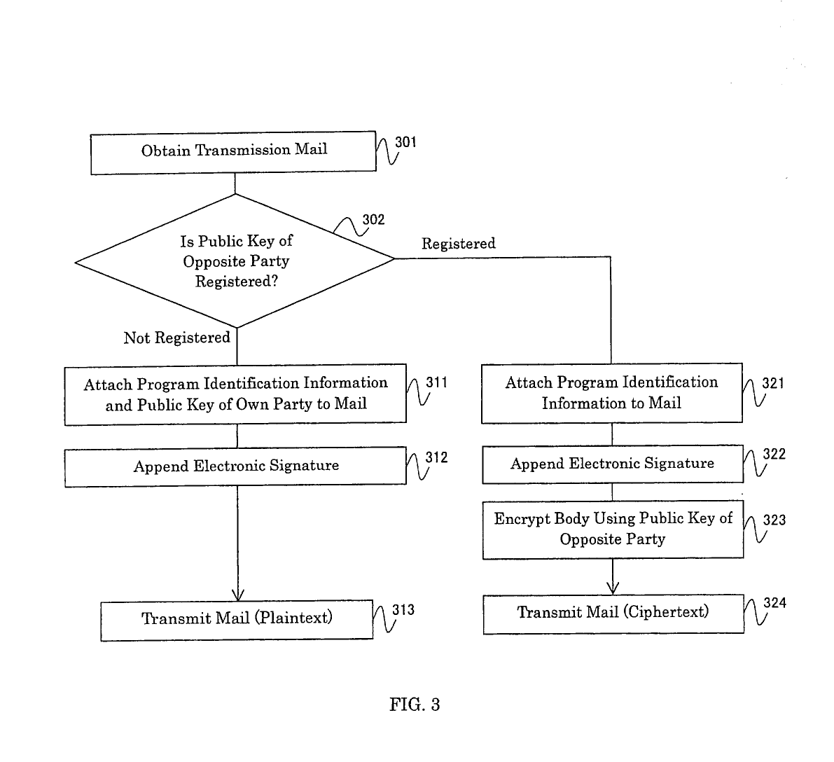

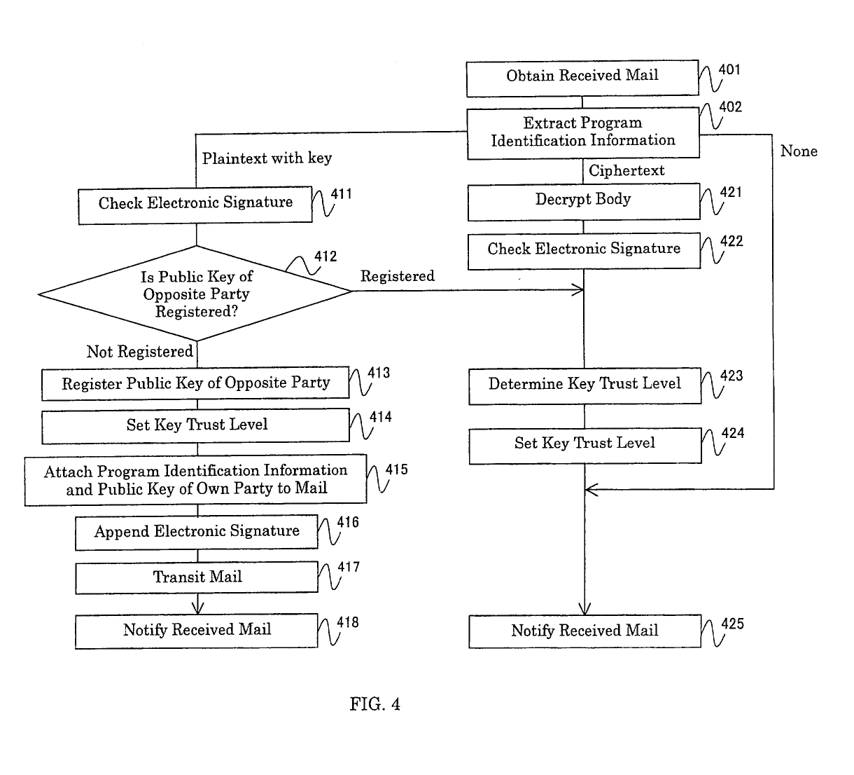

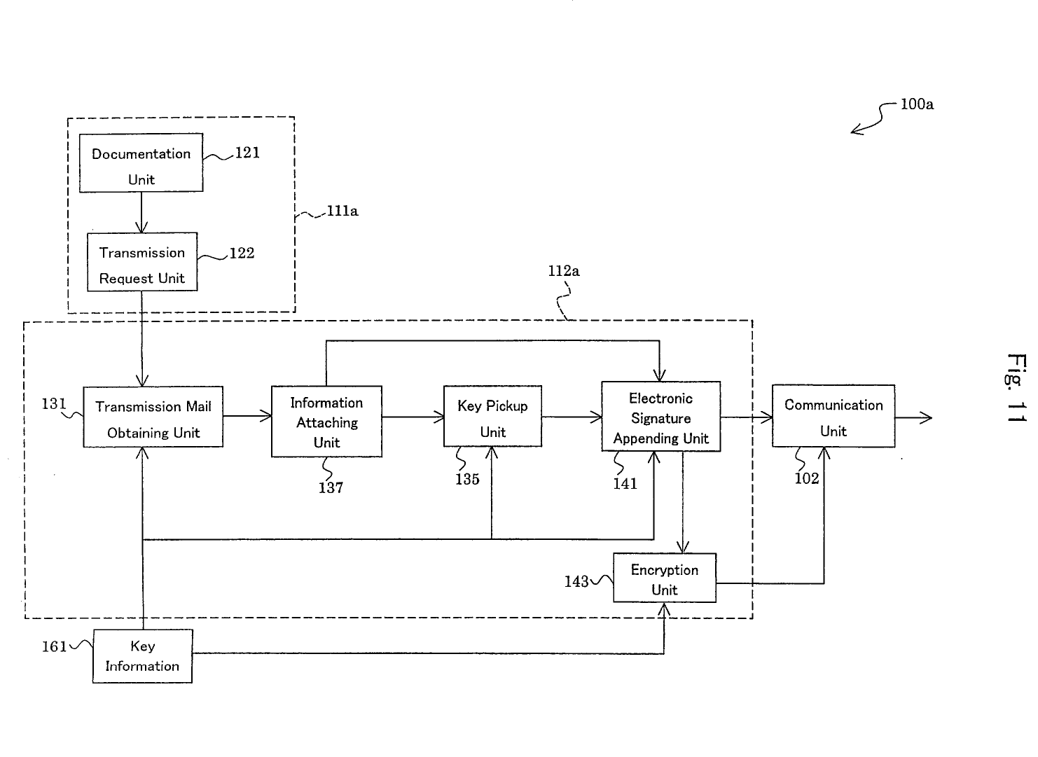

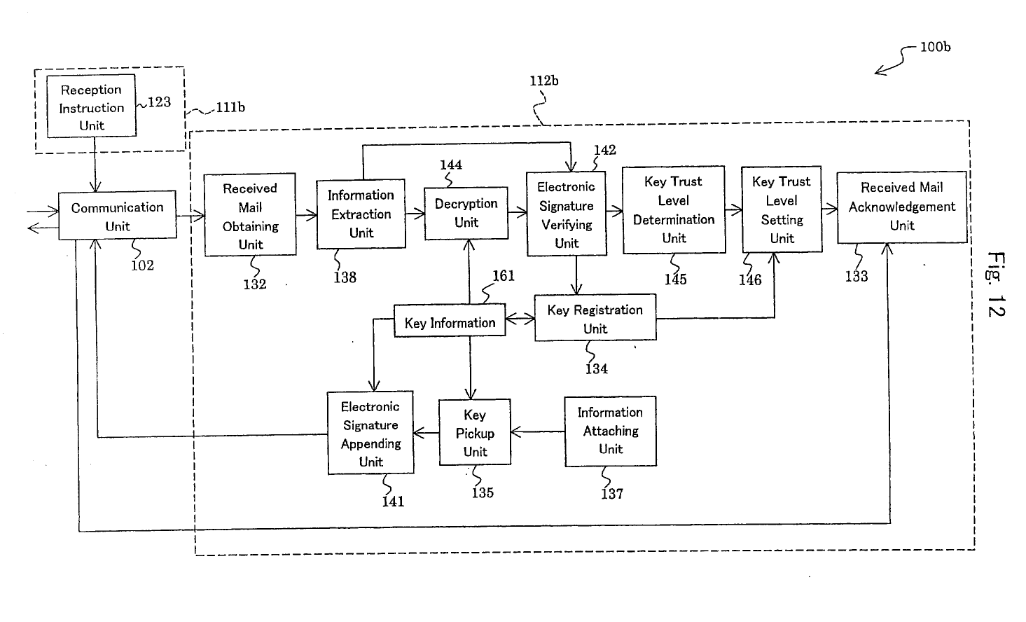

The following section describes an operation of the key exchange apparatus relating to the embodiment of the present invention while referring to flowcharts in FIG. 3 and FIG. 4. The flowchart in FIG. 3 describes the operation of a computer 100a (a first communication terminal), and the flowchart in FIG. 4 describes the operation of a computer 100b (a second communication terminal). While FIG. 1 shows the constitution of the key exchange apparatus, FIG. 11 shows a part of the constitution of the computer 100a (the first communication terminal) for describing a flow of data, and FIG. 12 shows a part of the constitution of the computer 100b (the second communication terminal) for describing a flow of data.

Referring to FIG. 3 and FIG. 11, the documentation unit 121 of the mailer 111a in the computer 100a (the first communication terminal) is used to create an electronic mail. The transmission request unit 122 requests for transmitting the created electronic mail. Namely the electronic mail is transmitted to the proxy server 112a as a transmission mail. The transmission mail is obtained by the transmission mail obtaining unit 131 in the proxy server 112a (Step 301).

The transmission mail obtaining unit 131 refers to the key information 161, and determines whether a public key (a second encryption key) of the opposite party (the computer 100b) is registered to the key information 161 (Step 302). The public key (the second encryption key) of the opposite party (the computer 100b) is a key used for encrypting when an electronic mail or the like is transmitted to the opposite party.

If the public key is not registered (Step 302, not registered), program identification information indicating that a public key is attached, and the public key (a first encryption key) of the computer 100a are attached to the transmission mail (Step 311). For example, they are attached to a header of the transmission mail. In more detail, the information attaching unit (first program information attaching unit) 137 obtains the transmission mail from the transmission mail obtaining unit 131, attaches program identification information indicating that the public key is attached to the transmission mail, and provides it as an output. Further, the key pickup unit 135 (first key transmission unit) reads out the public key of the own party (the computer 100a) from the key information 161, attaches the public key to the transmission mail provided from the information attaching unit 137, and provides it as an output. The public key (the first encryption key) of the own party (the computer 100a) is a key used when an electronic mail or the like is transmitted to the own party.

Then, the electronic signature appending unit (first signature appending unit) 141 reads out a secret key (a first decryption key) of the own party (the computer 100a) from the key information 161, and appends an electronic signature to the transmission mail using the secret key (Step 312). The electronic signature is used by the opposite party (the computer 100b) for authenticating the identity the sender of the transmission mail, and the validity of a body of the transmission mail. Specifically, a hash value of the body of the transmission mail is encrypted by the secret key (the first decryption key) of the own party (the computer 100a), and is attached to the transmission mail. The secret key (the first decryption key) of the own party (the computer 100a) is a key for decrypting information encrypted by the public key (the first encryption key) of the own party (the computer 100a).

Finally, the communication unit 102 obtains the transmission mail (the plaintext with the key) from the electronic signature appending unit 141, and transmits it to the opposite party (the computer 100b) (Step 313).

If the public key (the second encryption key) of the opposite party (the computer 100b) is registered to the key information 161 (Step 302, registered), program identification information indicating that the transmission mail is encrypted is attached to the transmission mail (Step 321).

Then, the electronic signature appending unit (first signature appending unit) 141 reads out a secret key (a first decryption key) of the own party (the computer 100a) from the key information 161, and appends an electronic signature to the transmission mail using the secret key (Step 322).

Then, the encryption unit 143 (encrypted mail transmission unit) obtains the transmission mail from the electronic signature appending unit 141. Further, the encryption unit 143 reads out the public key (the second encryption key) of the opposite party (the computer 100b), and encrypts the transmission mail using the public key (the second encryption key) (Step 323).

Finally, the communication unit 102 obtains the transmission mail (the ciphertext) from the encryption unit 143, and transmits it to the opposite party (the computer 100b) (Step 324).

Then, referring to FIG. 4 and FIG. 12, if the reception instruction unit 123 instructs the communication unit 102 of the computer 100b (the second communication terminal) to receive an electronic mail, the received mail obtaining unit 132 obtains the electronic mail (the received mail) through the communication unit 102 (Step 401).

Then, the information extraction unit 138 extracts the program identification information attached to the received mail (Step 402).

If the program identification information indicates that the electronic mail is attached with the public key (the first encryption key) (Step 402, the plaintext with the key), the electronic signature verifying unit 142 (first signature verifying unit) checks the electronic signature (Step 411). Specifically, the electronic signature verifying unit 142 decrypts the hash value of the body of the electronic mail using the first encryption key, compares it with a hash value obtained from the body of the electronic mail, and checks identity of a sender of the electronic mail, and the electronic mail body is not tampered.

Then, the key registration unit 134 refers to the key information 161 so as to determine whether the public key (the first encryption key) of the computer 100a is registered (Step 412).

If the public key is not registered (Step 412, not registered), the key registration unit 134 of the computer 100b registers the public key (the first encryption key) of the computer 100a to the key information 161 (Step 413).

The key trust level setting unit (first encryption key trust level setting unit) 146 sets the key trust level as a value indicating a temporary state into the key trust level information 162 (Step 414).

Then, program identification information indicating that a public key is attached, and the public key (the second encryption key) of the computer 100b are attached to an electronic mail transmitted to the computer 100a (Step 415). More specifically, information attaching unit (second program identification information attaching unit) 137 attaches the program identification information indicating that the public key (the second encryption key) of the computer 100b is attached to the electronic mail transmitted to the computer 100a to a transmission mail, and provides it as an output. Further, the key pickup unit 135 (second key transmission unit) reads out the public key (the second encryption key) of the computer 100b from the key information 161, attaches the public key to the electronic mail provided from the information attaching unit 137, and provides it as an output.

Then, the electronic signature appending unit (second signature appending unit) 141 reads out a secret key (a second decryption key) of the computer 100b from the key information 161, and appends an electronic signature to the electronic mail using the secret key (Step 416). The electronic signature is used by the computer 100a for authenticating the identity the sender of the electronic mail, and the validity of the body of the electronic mail. Specifically, a hash value of the body of the electronic mail is encrypted by the secret key (the second decryption key) of the computer 100b, and is attached to the transmission mail. The secret key (the second decryption key) of the computer 100b is a key for decrypting information encrypted by the public key (the second encryption key) of the computer 100b.

Then, the communication unit 102 obtains the transmission mail (the plaintext with the key) from the electronic signature appending unit 141, and transmits it to the computer 100a (Step 417).

Finally, the received mail acknowledgement unit 133 notifies a user of the computer 100b of the reception of the received mail (Step 418).

The transmission mail (the plaintext with the key) transmitted to the computer 100a is processed by the computer 100a. The processing is similar to the Steps 401, 402, 411, 412, 413, 414, and 418. Namely, when the transmission mail (the plaintext with the key) is obtained, the information extraction unit 138 of the computer 100a extracts the program identification information. Since the program identification information indicates that the electronic mail is attached with the public key (the second encryption key), the electronic signature verifying unit (second signature verifying unit) 142 checks the electronic signature. The key registration unit 134 refers to the key information 161 so as to determine whether the public key (the second encryption key) of the computer 100b is registered. Since the public key is not registered, the key registration unit 134 of the computer 100a registers the public key (the second encryption key) of the computer 100b to the key information 161. Then, the key trust level setting unit (second encryption key trust level setting unit) 146 sets the key trust level as a value indicating a temporary state into the key trust level information 162. Then, the received mail acknowledgement unit 133 notifies the user of the computer 100a of the reception of the mail.

If the program identification information attached to the received mail indicates that the received mail is the encrypted electronic mail (Step 402, the ciphertext), the decryption unit (first electronic mail decryption unit) 144 picks up the secret key (the second decryption key) of the computer 100b from the key information 161, and uses the secret key to decrypt the electronic mail body (Step 421). Then, the electronic signature verifying unit 142 checks an electronic signature (Step 422). This step is similar to Step 411. Then, key trust level determination unit 145 determines the key trust level (Step 423), and the key trust level setting unit 146 sets the key trust level into the key trust level information 162 (Step 424). Then, the received mail acknowledgement unit 133 notifies the user of the computer 100b of the reception of the received mail as in Step 418 (Step 425).

If the program identification information is not attached to the received mail, only the reception acknowledgement is conducted (Step 425). If the program identification information indicates that the electronic mail is attached with the public key (the first encryption key), and the public key (the first encryption key) of the computer 100a has been registered (Step 412, registered), determining key trust level (Step 423), setting the key trust level (Step 424), and notifying reception of the received mail (Step 425) are conducted.

The computer 100a may receive an electronic mail encrypted by the first encryption key from the computer 100b. Processing in this case is similar to that described in Steps 401, 402, 421, 422, 423, 424, and 425. First, an electronic mail encrypted by the encryption unit 143 of the computer 100b using the first encryption key is transmitted to the computer 100a. Since the information extraction unit 138 indicates that the mail is encrypted, the decryption unit (second electronic mail decryption unit) 144 picks up the secret key (the first decryption key) of the computer 100a from the key information 161, and uses the secret key to decrypt the electronic mail body. Then, the electronic signature verifying unit (the second signature verifying unit) 142 checks the electronic signature. This step is similar to the step 411. Then, key trust level determination unit (second encryption key trust level determination unit) 145 determines the key trust level, and the key trust level setting unit (second encryption key trust level setting unit) 146 sets the key trust level into the key trust level information 162. Then, the received mail acknowledgement unit 133 notifies a user of the computer 100a of the reception of the received mail as in Step 418.

Though it is not shown in the flowcharts in FIG. 3 and FIG. 4, it is possible to cancel delivery acknowledgement of an electronic mail, and an electronic mail.

Namely, if the electronic signature verifying unit (the first signature verifying unit) 142 of the computer (the second communication terminal) 100b checks the electronic signature, and determines that it is correct, the delivery acknowledgement unit (first delivery acknowledgement information transmission unit) 151 transmits first delivery acknowledgement information indicating that an electronic mail is delivered from the computer (the first communication terminal) 100a to the computer (the second communication terminal) 100b. The transmission may be conducted via an electronic mail or the like.

Also if the electronic signature verifying unit (the second signature verifying unit) 142 of the computer (the first communication terminal) 100a checks the electronic signature, and determines that it is correct, the delivery acknowledgement unit (second delivery acknowledgement information transmission unit) 151 transmits second delivery acknowledgement information indicating that an electronic mail is delivered from the computer (the second communication terminal) 100b to the computer (the first communication terminal) 100a to the computer (the second communication terminal) 100b. The transmission may be conducted via an electronic mail or the like.

Further, if the electronic signature verifying unit (the first signature verifying unit) 142 of the computer (the second communication terminal) 100b checks an electronic signature, and determines that it is correct, canceling a mail is approved. Namely, if the cancel request for a mail is transmitted from the mail cancel request unit (first mail cancel request unit) 154 of the computer (the first communication terminal) 100a to the computer (the second communication terminal) 100b, the mail cancel unit (first mail cancel unit) 152 deletes the mail transmitted from the computer (the first communication terminal) 100a to the computer (the second communication terminal) 100b. The result of the deletion may be notified to the computer (the first communication terminal) 100a via an electronic mail or the like.

Similarly, if the electronic signature verifying unit (the second signature verifying unit) 142 of the computer (the first communication terminal) 100a checks an electronic signature, and determines that it is correct, canceling a mail is approved. Namely, if cancel request for a mail is transmitted from the mail cancel request unit (second mail cancel request unit) 154 of the computer (the second communication terminal) 100b to the computer (the first communication terminal) 100a, the mail cancel unit (second mail cancel unit) 152 deletes the mail transmitted from the computer (the second communication terminal) 100b to the computer (the first communication terminal) 100a. The result of the deletion may be notified to the computer (the second communication terminal) 100b via an electronic mail or the like.

If the computer 100a (100b) transmits encrypted mails to multiple computers 100b (100a), the second encryption keys (the first encryption keys) of the multiple computers 100b (100a) registered to the key information 161 of the computer 100a (100b) are read out for the encryption.

Further, the computer 100a (100b) includes the key trust level treating unit 147, and treats an electronic mail based on a key trust level set in the key trust level information 162 of the computer 100a (100b).

Specifically, it sets a key trust level based on attached information of a received electronic mail, and, for instance, the key trust level of a corresponding encryption key is determined based on past communication history with a corresponding sender such as correct key reception information recorded in the memory unit 160 in advance, and route information of an electronic mail recorded in incorrect content detection information, and the key trust level is increased if it is determined that the key trust level of the corresponding encryption key is high. At this time, if it is determined that the key trust level of the corresponding encryption key is extremely low, the corresponding encryption key and the electronic mail are discarded following a determination of an user.

If an electronic mail attached with a public key different from a public key registered to the memory unit 160 in advance is received, the key trust level of the corresponding encryption key is determined based on the past communication history with the corresponding sender such as the correct key reception information recorded in the memory unit 160 in advance, and the route information of the electronic mail recorded in the incorrect content detection information, and the corresponding encryption key is newly registered to the memory unit 160, or is discarded following a determination of a user.

The following section describes a principle of determining the key trust level. The first encryption key used for the encryption for transmitting information to the computer (the first communication terminal) 100a is recorded on the computer (the second communication terminal) 100b. A route of an electronic mail (such as through which mail servers and in what order the electronic mail passes) transmitted from the computer 100a to the computer 100b is almost constant however many times an electronic mail may be transmitted.

The route of an electronic mail to which the first encryption key is attached is recorded in the key trust level information 162 of the computer 100b. When a new electronic mail to which the first encryption key is attached arrives, it is determined the first encryption key is correct or not by comparing with the recorded path. Namely, if the transmitted path is almost the same as the recorded path, the key is the correct encryption key transmitted from the computer 100a. If the transmitted path and the recorded path are largely different, the key is an incorrect first encryption key transmitted from a third party impersonating the computer 100a. If this incorrect first encryption key is used for encryption, information intended to transmit to the computer 100a is stolen by the third party impersonating the computer 100a. Thus, the incorrect first encryption key is not used.

Also, a user may use the operation unit 103 to enter a key trust level for individual opposite parties of electronic mails, and the entered key trust levels may be set in the key trust level information 162 in the memory unit 160.

In addition, if incorrectness is determined, history information such as an incorrect key and the mail address of the incorrect opposite party may be registered.

Further, if incorrectness is determined, the reproduction unit 101 may warns the user via a display or a sound output.

The following section describes processing relating to a mailing list.

With electronic mails used with a mailing list, if a member registered to the mailing list transmits an electronic mail to a mailing list server maintaining the mailing list to which mail addresses of multiple members are registered, the mailing list server distributes the electronic mail to the all members registered to the mailing list. Also, a person requesting for registering to the mailing list generally transmits a registration request mail to an administrator administrating the mailing list from a computer of the requesting person, and the mail address of the requesting person is registered to the mailing list maintained by the mailing list server via a computer of the administrator.

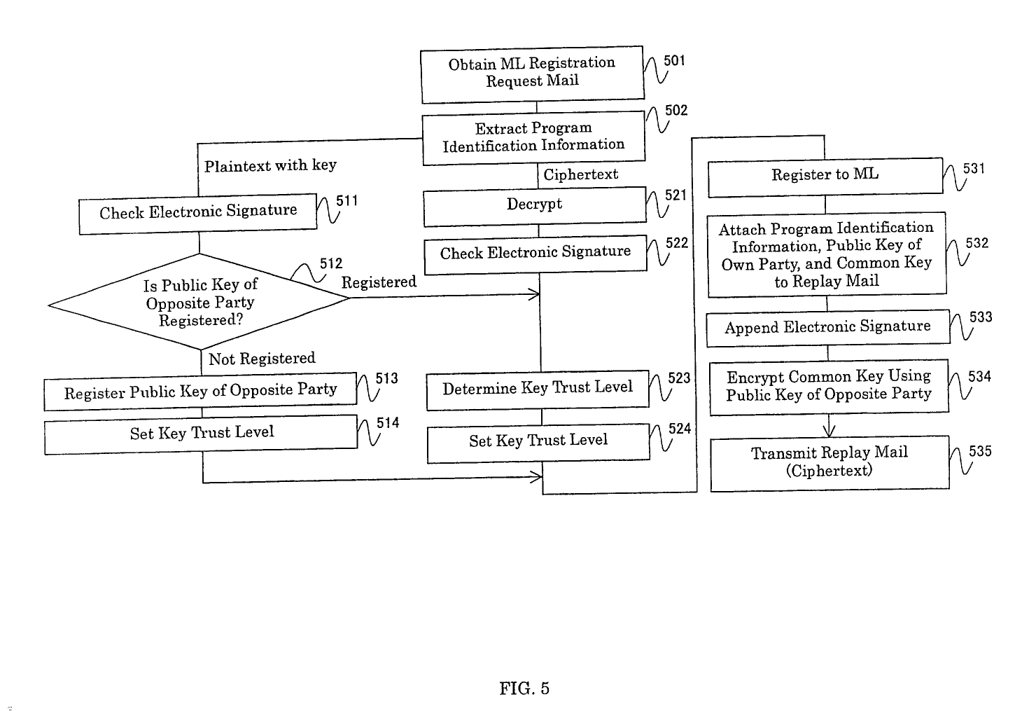

FIG. 5 shows a flowchart showing reception processing for a mailing list registration request mail on the computer (the second communication terminal) 100b of the administrator. The registration requesting person transmits the mailing list registration request mail from the computer (the first communication terminal) 100a.

Referring to FIG. 5, if the reception instruction unit 123 instructs the communication unit 102 of the computer (the second communication terminal) 100b to receive the mailing list registration request mail, the received mail obtaining unit 132 obtains the mailing list registration request mail through the communication unit 102 (Step 501).

Then, the information extraction unit 138 extracts program identification information attached to the mailing list registration request mail (Step 502).

If the program identification information indicates that the electronic mail is attached with the public key (the first encryption key) (Step 502, a plaintext with a key), the electronic signature verifying unit (the first signature verifying unit) 142 checks an electronic signature (Step 511). This step is similar to Step 411.

Then, the key registration unit 134 refers to the key information 161 so as to determine whether the public key (the first encryption key) of the computer 100a is registered (Step 512).

If the public key is not registered (Step 512, not registered), the key registration unit 134 of the computer 100b registers the public key (the first encryption key) of the computer 100a to the key information 161 (Step 513).

Then, the key trust level setting unit (the first encryption key trust level setting unit) 146 sets the key trust level as a value indicating a temporary state in the key trust level information 162 (Step 514).

Then, the ML (mailing list) processing unit 153 of the computer 100b records the mail address of the registration requesting person to the memory unit 160 (Step 531).

Then, program identification information indicating that the public key is attached, and the public key (the second encryption key) of the computer 100b and a common key are attached to an electronic mail transmitted to the computer 100a (Step 532). This step is similar to Step 415 except for adding to the common key. The common key is a key for encrypting a mail distributed from the mailing list. The common key is read out from the key information 161, and is attached to the electronic mail by the ML processing unit 153.

Then, the electronic signature appending unit (second signature appending unit) 141 reads out the secret key (the second decryption key) of the computer 100b from the key information 161, and appends an electronic signature to the electronic mail using the secret key (Step 533). This step is similar to Step 416.

The ML processing unit 153 encrypts the common key using the public key (the first encryption key) of the computer 100a (Step 534).

Finally, the communication unit 102 obtains the transmission mail (the ciphertext: the common key is encrypted) from the electronic signature appending unit 141, and transmits it to the computer 100a (Step 535).

If the program identification information attached to the mailing list registration request mail indicates that the mail is an encrypted electronic mail (Step 502, a ciphertext), the decryption unit (the first electronic mail decryption unit) 144 picks up the secret key (the second decryption key) of the computer 100b from the key information 161, and uses the secret key to decrypt the electronic mail body (Step 521). Then, the electronic signature verifying unit 142 checks an electronic signature (Step 522). This step is similar to Step 411. Then, key trust level determination unit 145 determines the key trust level (Step 523), and the key trust level setting unit 146 sets the key trust level in the key trust level information 162 (Step 524). Then, Steps 531, 532, 533, 534, and 535 are conducted.

If the program identification information indicates that the electronic mail is attached with the public key (the first encryption key), and the public key (the first encryption key) of the computer 100a is registered (Step 512, registered), determining key trust level (Step 523), and setting the key trust level (Step 524) are conducted. Then, Steps 531, 532, 533, 534, and 535 are conducted.

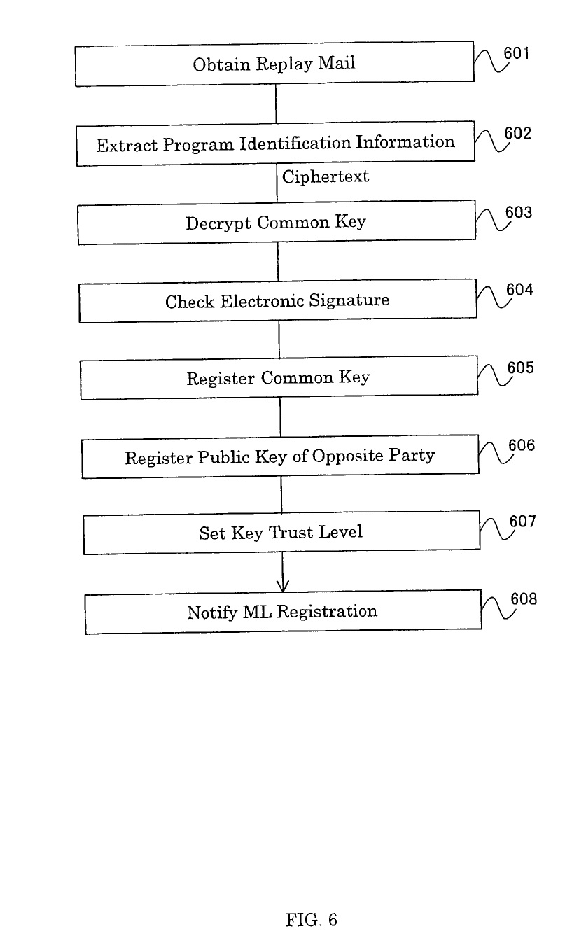

FIG. 6 is a flowchart showing reception processing for a replay mail to the mailing list registration request mail on the computer 100a of the registration requesting person.

In FIG. 6, the replay mail transmitted to the computer 100a is processed by the computer 100a.

If the reception instruction unit 123 instructs the communication unit 102 of the computer 100a (the first communication terminal) to receive an electronic mail, the received mail obtaining unit 132 obtains the reply mail through the communication unit 102 (Step 601).

Then, the information extraction unit 138 of the computer 100a extracts program identification information (Step 602).

Since the program identification information indicates that the electronic mail is attached with the public key (the second encryption key), the ML processing unit 153 decrypts the common key using the secret key (the first decryption key) (Step 603).

Then, the electronic signature verifying unit (the second signature verifying unit) 142 checks the electronic signature (Step 604).

Further, the key registration unit 134 of the computer 100a registers the common key to the key information 161 (Step 605), and registers the public key (the second encryption key) of the computer 100b to the key information 161 (Step 606).

Then, the key trust level setting unit (the second encryption key trust level setting unit) 146 sets the key trust level as a value indicating a temporary state in the key trust level information 162 (Step 607). Then, the received mail acknowledgement unit 133 notifies the user of the computer 100a of the registration to the mailing list (Step 608).

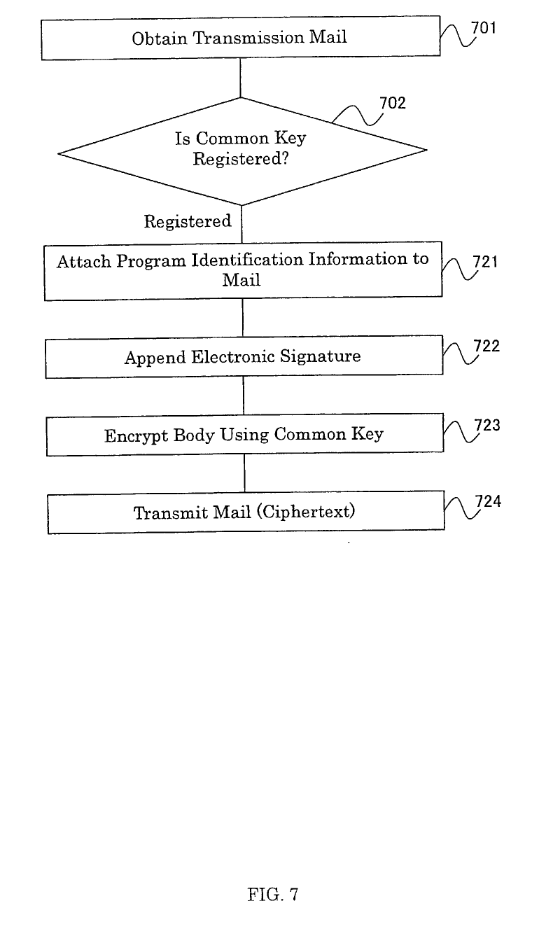

FIG. 7 is a flowchart showing transmission processing when a person registered to the mailing list uses the computer (the first communication terminal) 100a to transmit a mail to the computer (the first communication terminal) 100a of another person registered to the mailing list via the computer (the second communication terminal) 100b.

Roughly described, the mail body is encrypted on the computer (the first communication terminal) 100a using the common key. Then, it is transmitted to the computer (the first communication terminal) 100a of the opposite person via the computer (the second communication terminal) 100b. The mail body is decrypted using the common key on the computer (the first communication terminal) 100a of the opposite person.

In FIG. 7, the documentation unit 121 of the mailer 111 in the computer (the first communication terminal) 100a is used to create an electronic mail. The transmission request unit 122 requests for transmitting the created electronic mail. Namely the electronic mail is transmitted to the proxy server 112 as a transmission mail. The transmission mail is obtained by the transmission mail obtaining unit 131 in the proxy server 112 (Step 701).

The transmission mail obtaining unit 131 refers to the key information 161, and determines whether the common key is registered to the key information 161 (Step 702).

Since the key is registered, program identification information indicating that the transmission mail is encrypted is attached to the transmission mail (Step 721).

Then, the electronic signature appending unit (the first signature appending unit) 141 reads out the secret key (the first decryption key) of the own party (the computer 100a) from the key information 161, and appends an electronic signature to the transmission mail using the secret key (Step 722).

Then, the encryption unit 143 (the encrypted mail transmission unit) obtains the transmission mail from the electronic signature appending unit 141. Further, the encryption unit 143 reads out the common key from the key information 161, and encrypts the transmission mail using the common key (Step 723).

Finally, the communication unit 102 obtains the transmission mail (the ciphertext) from the encryption unit 143, and transmits it to the computer 100b (Step 724).

When the administrator changes the common key, the common key registered to the memory unit 160 is changed. Then, the changed common key is encrypted by the first encryption key of the computer (the first communication terminal) 100a of the individual registered persons, and is transmitted to the computer 100a of the individual registered persons. The computer (the first communication terminal) 100a of the individual registered persons receives the encrypted common key, decrypts it using the first decryption key, and registers it to the key information 161.

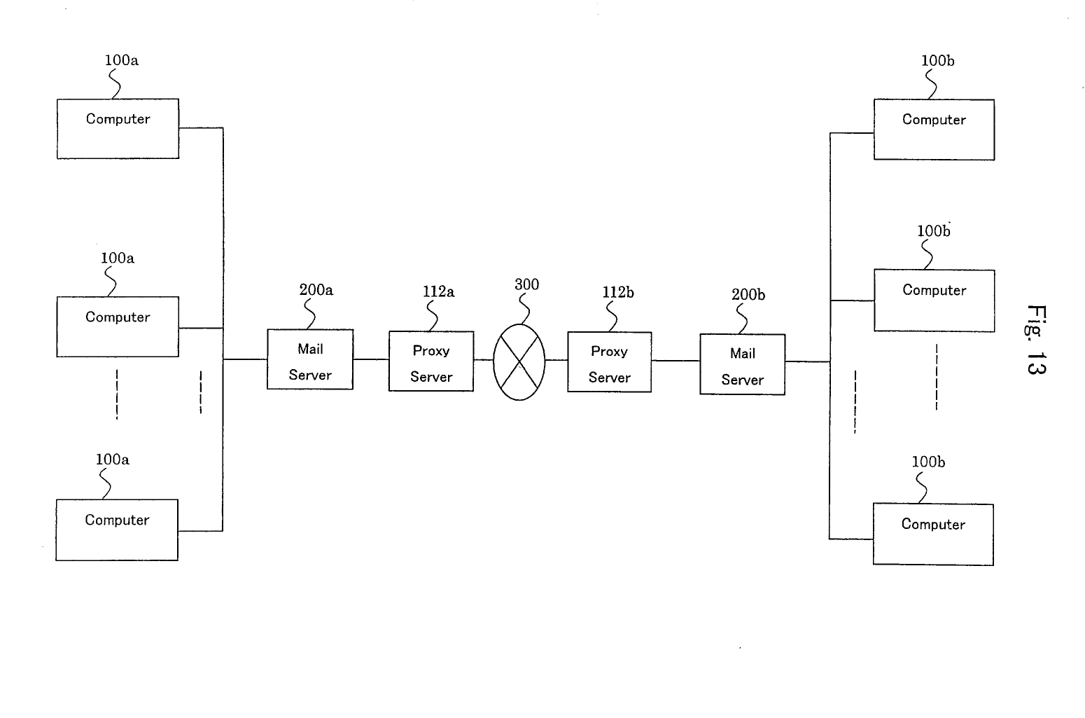

While the section above describes a form where the proxy server 112 is integrated into the computer 100 (see FIG. 2), the proxy server 112 may be provided outside the computer 100. FIG. 13 shows an example where the proxy server 112 is provided outside the computer 100.

As shown in FIG. 13, the computer 100a (the first communication terminal) is connected with a known mail server 200a. The mail server 200a is connected with the Internet 300 through a proxy server 112a. The computer 100b (the second communication terminal) is connected with a known mail server 200b. The mail server 200b is connected with the Internet 300 through a proxy server 112b.

In the embodiment described above, if there is an electronic mail to be transmitted, and the public key of the computer (the second communication terminal) 100b is not registered, the electronic mail is transmitted without encryption as shown in FIG. 3. However, the public key of the opposite party may be obtained from a key server which manages key information, and the electronic mail may be encrypted, and may be transmitted to the opposite party.

Also, in the embodiment described above, as shown in FIG. 4, when the public key of the computer (the first communication terminal) 100a is received, the public key of the computer (the second communication terminal) 100b is distributed to the computer (the first communication terminal) 100a. However, the user operates the mailer to attach the public key when the mail is replied. Also, a case where the public key is distributed at arbitrary timing is included. For example, a series of the steps (Steps 415, 416, and 417) for transmitting the second encryption key to the computer (the first communication terminal) 100a may be conducted at arbitrary timing on the computer (the second communication terminal) 100b shown in FIG. 4.

Also, the program identification information and the common key may be attached to the header of an electronic mail or to a text itself of the body. They may be attached as a content.

In addition, the determination of an incorrect key is not limited to using a past communication history or a content of an electronic mail. For example, an incorrect key may be detected by using information from a key server for accumulating incorrect key information, or referring to a history of a program for detecting a computer virus, a history of a program for browsing a homepage, and a history of other programs.

Additionally, how to obtain an electronic mail is not limited to the obtaining method with registering the names of the mail transmission server and the mail reception server to the memory unit. Another method such as obtaining an electronic mail while monitoring communication between the mailer and the mail transmission server, or communication between the mailer and the mail reception server may be used.

Also, the computer is not limited to a personal computer, and may be microcomputer embedded into various types of apparatuses, a portable phone, a PDA (Personal Digital Assistant), or any other computers.

Further, the embodiment described above may be realized in the following way. A media reader of a computer provided with a CPU, a hard disk, and the media (such as a floppy disk and a CD-ROM) reader reads a medium recording a program realizing the individual parts described above, and then, the program is installed on the hard disk. The embodiment above may be realized in this way.

With the key exchange apparatus constituted as described above, since the first encryption key and the second encryption key are exchanged, the keys used for the encryption between the first communication terminal 100a and the second communication terminal 100b are obtained. Namely, the trusted section is formed between the first communication terminal 100a and the second communication terminal 100b.

Also, the first encryption key and the second encryption key are exchanged by transmitting or receiving an electronic mail. For example, the first encryption key and the second encryption key are exchanged by operating a mailer or the like which is software for transmitting and receiving an electronic mail. Thus, the first encryption key and the second encryption key are exchanged easily.

Further, if the first communication terminal 100a has not received the second encryption key, the first encryption key and the second encryption key have not been exchanged. Thus, if the first encryption key is transmitted from the first communication terminal 100a, the first encryption key and the second encryption key are exchanged.

Also, if the first communication terminal 100a has received the second encryption key, the first encryption key and the second encryption key have been exchanged. Then, if an electronic mail is encrypted, and then is transmitted, it is possible to prevent a third party from incorrectly obtaining the electronic mail.

Since the first encryption key and the second encryption key have been exchanged, it is possible to use a so-called electronic signature so as to conduct authenticate between the first communication terminal 100a and the second communication terminal 100b.

Since authentication between the first communication terminal 100a and the second communication terminal 100b is possible, it is possible to transmit such information as indicating that an electronic mail has delivered, which should not be disclosed to a third party.

Also, since authentication between the first communication terminal 100a and the second communication terminal 100b is possible, it is possible to confirm that such a request as canceling an electronic mail, which should not be used by a third party incorrectly, is transmitted from a correct sender of the electronic mail. Thus, the electronic mail can be safely deleted on request for canceling the electronic mail.

When the first encryption key and the second encryption key are changed, it is considered that routes through which they are transmitted are almost constant. Thus, it is possible to determine whether the first encryption key and the second encryption key are being changed correctly or changed incorrectly by a third party based on the paths of the transmission.

With the present invention, since the first encryption key and the second encryption key are exchanged, it is possible to obtain keys used for encryption between the first communication terminal and the second communication terminal.

What is claimed is:

1. A key exchange apparatus comprising:
a first key transmission unit for transmitting a first encryption key used for encrypting when information is transmitted to a first communication terminal;
a first key reception unit for receiving said first encryption key;
a second key transmission unit for transmitting a second encryption key used for encrypting when information is transmitted to a second communication terminal in response to reception of said first encryption key; and
a second key reception unit for receiving said second encryption key.

2. A key exchange apparatus comprising:
a first key transmission unit for transmitting a first encryption key used for encrypting when information is transmitted to a first communication terminal; and
a second key reception unit for receiving a second encryption key transmitted in response to the transmission of said first encryption key, and used for encrypting when information is transmitted to a second communication terminal.

3. A key exchange apparatus comprising:
a first key reception unit for receiving a first encryption key used for encrypting when information is transmitted to a first communication terminal; and
a second key transmission unit for transmitting a second encryption key used for encrypting when information is transmitted to a second communication terminal in response to reception of said first encryption key.

4. The key exchange apparatus according to claim 1, wherein
said first encryption key and said second encryption key are transmitted in response to a transmission of an electronic mail communicated between said first communication terminal and said second communication terminal, and
said first encryption key and said second encryption key are received in response to a reception of an electronic mail communicated between said first communication terminal and said second communication terminal.

5. The key exchange apparatus according to claim 2, wherein said first encryption key is transmitted in response to a transmission of an electronic mail from said first communication terminal to said second communication terminal, and said second encryption key is received in response to a reception of an electronic mail by said first communication terminal, the electronic mail transmitted from said second communication terminal.

6. The key exchange apparatus according to claim 3, wherein said first encryption key is received in response to a reception of an electronic mail by said second communication terminal, the electronic mail transmitted from said first communication terminal, and said second encryption key is transmitted in response to a transmission of an electronic mail from said second communication terminal to said first communication terminal.

7. The key exchange apparatus according to claim 5, wherein said first key transmission unit transmits said first encryption key while said first encryption key is attached to a plaintext electronic mail if said second encryption key has not been received by said second key reception unit.

8. The key exchange apparatus according to claim 5, wherein an electronic mail encrypted by said second encryption key is transmitted to said second communication terminal if said second encryption key has been received by said second key reception unit.

9. The key exchange apparatus according to claim 4 further comprising:
a first signature appending unit for attaching first signature information encrypted by a first decryption key which can decrypt information encrypted by said first encryption key to a first electronic mail transmitted from said first communication terminal to said second communication terminal;
a first signature verifying unit for receiving said first electronic mail, and authenticating said first signature information by decrypting said first signature information with said first encryption key;
a second signature appending unit for attaching second signature information encrypted by a second decryption key which can decrypt information encrypted by said second encryption key to a second electronic mail transmitted from said second communication terminal to said first communication terminal; and
a second signature verifying unit for receiving said second electronic mail, and authenticating said second signature information by decrypting said second signature information with said second encryption key.

10. The key exchange apparatus according to claim 5 further comprising:
a first signature appending unit for attaching first signature information encrypted by a first decryption key which can decrypt information encrypted by said first encryption key to a first electronic mail transmitted from said first communication terminal to said second communication terminal; and
a second signature verifying unit for receiving said second electronic mail attached with second signature information encrypted by a second decryption key which can decrypt information encrypted by said second encryption key, and transmitted from said second communication terminal to said first communication terminal, and authenticating said second signature information by decrypting said second signature information with said second encryption key.

11. The key exchange apparatus according to claim 6 further comprising:
a first signature verifying unit for receiving said first electronic mail attached with first signature information encrypted by a first decryption key which can decrypt information encrypted by said first encryption key, and transmitted from said first communication terminal to said second communication terminal, and authenticating said first signature information by decrypting said first signature information with said first encryption key; and
a second signature appending unit for attaching second signature information encrypted by a second decryption key which can decrypt information encrypted by said second encryption key to a second electronic mail transmitted from said second communication terminal to said first communication terminal.

12. The key exchange apparatus according to claim 9 further comprising.
a first delivery acknowledgement information transmission unit for transmitting first transmission acknowledgement information showing said first electronic mail has been delivered from said second communication terminal to said first communication terminal if said first signature verifying unit authenticates said first signature information; and
a second delivery acknowledgement information transmission unit for transmitting second transmission acknowledgement information showing said second electronic mail has been delivered from said first communication terminal to said second communication terminal if said second signature verifying unit authenticates said second signature information.

13. The key exchange apparatus according to claim 10 further comprising a second delivery acknowledgement information transmission unit for transmitting second delivery acknowledgement information showing said second electronic mail has been delivered from said first communication terminal to said second communication terminal if said second signature verifying unit authenticates said second signature information.

14. The key exchange apparatus according to claim 11 further comprising a first delivery acknowledgement information transmission unit for transmitting first delivery acknowledgement information showing said first electronic mail has been delivered from said second communication terminal to said first communication terminal if said first signature verifying unit authenticates said first signature information.

15. The key exchange apparatus according to claim 9 further comprising:
a first electronic mail cancel request unit for transmitting a cancel request for said first electronic mail from said first communication terminal;
a first electronic mail cancel unit for deleting said first electronic mail from said second communication terminal if said first signature verifying unit authenticates said first signature information, and the cancel request for said first electronic mail is received;
a second electronic mail cancel request unit for transmitting a cancel request for said second electronic mail from said second communication terminal; and
a second electronic mail cancel unit for deleting said second electronic mail from said first communication terminal if said second signature verifying unit authenticates said second signature information, and the cancel request for said second electronic mail is received.

16. The key exchange apparatus according to claim 10 further comprising:
a first electronic mail cancel request unit for transmitting a cancel request for said first electronic mail from said first communication terminal; and
a second electronic mail cancel unit for deleting said second electronic mail from said first communication terminal if said second signature verifying unit authenticates said second signature information, and a cancel request for said second electronic mail is received.

17. The key exchange apparatus according to claim 11 further comprising:
a first electronic mail cancel unit for deleting said first electronic mail from said second communication terminal if said first signature verifying unit authenticate said first signature information, and a cancel request for said first electronic mail is received; and
a second electronic mail cancel request unit for transmitting a cancel request for said second electronic mail from said second communication terminal.

18. The key exchange apparatus according to claim 4 further comprising:
a first program identification information attaching unit for attaching first program identification information indicating whether a first electronic mail transmitted from said first communication terminal to said second communication terminal is encrypted with said second encryption key;
a first electronic mail decoding unit for receiving said first electronic mail, and decoding said first electronic mail if said first program identification information indicates the encryption with said second encryption key;
a second program identification information attaching unit for attaching second program identification information indicating whether a second electronic mail transmitted from said second communication terminal to said first communication terminal is encrypted with said first encryption key; and
a second electronic mail decoding unit for receiving said second electronic mail, and decoding said second electronic mail if said second program identification information indicates the encryption with said first encryption key.

19. The key exchange apparatus according to claim 5 further comprising:
a first program identification information attaching unit for attaching first program identification information indicating whether a first electronic mail transmitted from said first communication terminal to said second communication terminal is encrypted with said second encryption key; and
a second electronic mail decoding unit for receiving said second electronic mail attached with second program identification information indicating whether the second electronic mail is encrypted with said first encryption key, and transmitted from said second communication terminal to said first communication terminal, and decoding said second electronic mail if said second program identification information indicates the encryption with said first encryption key.

20. The key exchange apparatus according to claim 6 further comprising:
a first electronic mail decoding unit for receiving said first electronic mail attached with first program identification information indicating whether the first electronic mail is encrypted with said second encryption key, and transmitted from said first communication terminal to said second communication terminal, and decoding said first electronic mail if said first program identification information indicates the encryption with said second encryption key; and
a second program identification information attaching unit for attaching second program identification information indicating whether a second electronic mail transmitted from said second communication terminal to said first communication terminal is encrypted with said first encryption key.

21. The key exchange apparatus according to claim 5 further comprising a first electronic mail encryption unit for encrypting a first electronic mail transmitted from said first communication terminal to said multiple second communication terminals with said second encryption key corresponding to said individual second communication terminal.

22. The key exchange apparatus according to claim 6 further comprising a second electronic mail encryption unit for encrypting a second electronic mail transmitted from said second communication terminal to said multiple first communication terminals with said first encryption key corresponding to said individual first communication terminal.

23. The key exchange apparatus according to claim 4, wherein
said one first communication terminal transmits an electronic mail for a mailing list to said other first communication terminal through said second communication terminal,
said second key transmission unit transmits a common key in addition to said second encryption key,
said second key reception unit receives said second encryption key and said common key, and
said electronic mail for a mailing list is encrypted and decrypted with said common key.

24. The key exchange apparatus according to claim 5, wherein
said one first communication terminal transmits an electronic mail for a mailing list to said other first communication terminal through said second communication terminal,
said second key reception unit receives said second encryption key and a common key, and
said electronic mail for a mailing list is encrypted and decrypted with said common key.

25. The key exchange apparatus according to claim 6, wherein
said one first communication terminal transmits an electronic mail for a mailing list to said other first communication terminal through second communication terminal,
said second key transmission unit transmits a common key in addition to said second encryption key, and
said electronic mail for a mailing list is encrypted and decrypted with said common key.

26. The key exchange apparatus according to claim 23, wherein said common key is changeable.

27. The key exchange apparatus according to claim 4 further comprising:
a first encryption key trust level setting unit for setting a trust level of said first encryption key received by said first key reception unit; and
a second encryption key trust level setting unit for setting a trust level of said second encryption key received by said second key reception unit.

28. The key exchange apparatus according to claim 5 further comprising
a second encryption key trust level setting unit for setting a trust level of said second encryption key received by said second key reception unit.

29. The key exchange apparatus according to claim 6 further comprising
a first encryption key trust level setting unit for setting a trust level of said first encryption key received by said first key reception unit.

30. The key exchange apparatus according to claim 27, wherein
said first encryption key trust level setting unit sets the trust level of said first encryption key based on a route along which said first encryption key is transmitted, and
said second encryption key trust level setting unit sets the trust level of said second encryption key based on a route along which said second encryption key is transmitted.

31. The key exchange apparatus according to claim 28, wherein
said second encryption key trust level setting unit sets the trust level of said second encryption key based on a route along which said second encryption key is transmitted.

32. The key exchange apparatus according to claim 29, wherein
said first encryption key trust level setting unit sets the trust level of said first encryption key based on a route along which said first encryption key is transmitted.

33. The key exchange apparatus according to claim 27, wherein
the trust level of said first encryption key or said second encryption key is set by attached information of an electronic mail.

34. The key exchange apparatus according to claim 27, wherein
the trust level of said first encryption key or said second encryption key is set by whether an incorrect encryption key is received.

35. The key exchange apparatus according to claim 27, wherein
the trust level of said first encryption key or said second encryption key is entered by a user.

36. The key exchange apparatus according to claim 27 further comprising:
a first encryption key trust level treating unit for treating said first encryption key based on the trust level of said first encryption key; and
a second encryption key trust level treating unit for treating said second encryption key based on the trust level of said second encryption key.

37. The key exchange apparatus according to claim 28 further comprising:
a second encryption key trust level treating unit for treating said second encryption key based on the trust level of said second encryption key.

38. The key exchange apparatus according to claim 29 further comprising:
a first encryption key trust level treating unit for treating said first encryption key based on the trust level of said first encryption key.

39. The key exchange apparatus according to claim 36, wherein
the treating said first encryption key or said second encryption key is to invalidate said first encryption key or said second encryption key.

40. The key exchange apparatus according to claim 36, wherein
the treating said first encryption key or said second encryption key is to record said first encryption key or said second encryption key.

41. The key exchange apparatus according to claim 36, wherein
the treating said first encryption key or said second encryption key is to provide warning.

42. A key exchange method comprising:
a first key transmission step for transmitting a first encryption key used for encrypting when information is transmitted to a first communication terminal;
a first key reception step for receiving said first encryption key;
a second key transmission step for transmitting a second encryption key used for encrypting when information is transmitted to a second communication terminal in response to reception of said first encryption key; and
a second key reception step for receiving said second encryption key.

43. A key exchange method comprising:
a first key transmission step for transmitting a first encryption key used for encrypting when information is transmitted to a first communication terminal; and
a second key reception step for receiving a second encryption key transmitted in response to the transmission of said first encryption key, and used for encrypting when information is transmitted to a second communication terminal.

44. A key exchange method comprising:
a first key reception step for receiving a first encryption key used for encrypting when information is transmitted to a first communication terminal; and
a second key transmission step for transmitting a second encryption key used for encrypting when information is transmitted to a second communication terminal in response to reception of said first encryption key.

45. A program of instructions for execution by the computer to perform a key exchange process, said key exchange process comprising:
a first key transmission processing for transmitting a first encryption key used for encrypting when information is transmitted to a first communication terminal; and
a second key reception processing for receiving a second encryption key transmitted in response to the transmission of said first encryption key, and used for encrypting when information is transmitted to a second communication terminal.

46. A program of instructions for execution by the computer to perform a key exchange process, said key exchange process comprising:
a first key reception processing for receiving a first encryption key used for encrypting when information is transmitted to a first communication terminal; and
a second key transmission processing for transmitting a second encryption key used for encrypting when information is transmitted to a second communication terminal in response to reception of said first encryption key.

47. A computer-readable medium having a program of instructions for execution by the computer to perform a key exchange process, said key exchange process comprising:
a first key transmission processing for transmitting a first encryption key used for encrypting when information is transmitted to a first communication terminal; and
a second key reception processing for receiving a second encryption key transmitted in response to the transmission of said first encryption key, and used for encrypting when information is transmitted to a second communication terminal.

48. A computer-readable medium having a program of instructions for execution by the computer to perform a key exchange process, said key exchange process comprising
a first key reception processing for receiving a first encryption key used for encrypting when information is transmitted to a first communication terminal; and
a second key transmission processing for transmitting a second encryption key used for encrypting when information is transmitted to a second communication terminal in response to reception of said first encryption key.
